(19) United States
(12) Patent Application Publication
(10) Pub. No.: US 2025/0265623 A1
(43) Pub. Date: Aug. 21, 2025

(54) System and Method for Generating Real-time Project Estimates

(71) Applicant: Justin Smith, Orlando, FL (US)

(72) Inventor: Justin Smith, Orlando, FL (US)

(21) Appl. No.: 18/582,730

(22) Filed: Feb. 21, 2024

(51) Int. Cl. G06Q 30/0283; G06F 40/20; G06F 40/35; G06Q 50/08

(52) U.S. Cl. CPC G06Q 30/0283; G06Q 50/08

(57) ABSTRACT

Disclosed herein is a system and method for generating real-time project estimates and providing field assistance in the construction and home improvement industries. Utilizing AI and NLP, the system processes project requests, accesses a database of real-time material and labor costs, and generates detailed project estimates. It offers an interactive interface for voice and text inputs, dynamic estimate adjustments, and integrates with third-party software. Field assistance features installation tips, compliance information, and a feedback loop mechanism for continuous improvement.

### TECHNICAL FIELD

The present invention relates to the field of project estimation and management, particularly to systems and methods for generating real-time project estimates and providing field assistance using artificial intelligence (AI) and natural language processing (NLP) technologies in the construction and home improvement industries.

### BACKGROUND

The construction and field service management industries are critically dependent on accurate project estimations and effective field assistance to ensure operational efficiency, cost management, and client satisfaction. However, contractors and service technicians frequently encounter significant challenges in these areas due to the inherently complex and dynamic nature of construction projects. A predominant issue is the time-consuming process of manual estimations, which not only slows down project initiation but also introduces a high potential for errors. These inaccuracies can stem from outdated material costs, miscalculated labour rates, or overlooked project specifics, leading to budget overruns and strained client relationships.

Additionally, the lack of access to real-time data exacerbates these challenges. Traditional estimation methods fail to account for the fluctuating prices of materials and varying labour rates across different regions, resulting in estimates that are often out of sync with the current market conditions. This disconnect can cause significant discrepancies between estimated and actual project costs, undermining trust and reliability in the professional services offered by contractors and technicians.

In response to these challenges, several software solutions have been developed aiming to streamline the estimation process and provide support for field operations. These tools range from simple spreadsheet templates to more sophisticated project management software. However, many of these existing solutions fall short in addressing the core needs of the industry.

A common shortfall among these tools is the lack of real-time data integration. Most traditional software relies on static databases that require manual updates, meaning that the material costs and labour rates used for estimations may not reflect the current market reality. This limitation severely impacts the accuracy and reliability of the estimates produced.

Furthermore, existing solutions are often generic and not tailored to the specific needs of different trades within the construction industry, such as HVAC, plumbing, carpentry, electrical, and roofing. Each of these trades has unique requirements for project estimation and execution, which generic software tools fail to adequately support.

Another significant limitation is the absence of interactive assistance. While some software tools offer database queries and pre-filled templates for estimates, they lack the ability to engage with users in a conversational manner to clarify project details, ask follow-up questions, or provide customized recommendations. This lack of interactivity and personalization can lead to misunderstandings and oversights in the project estimation process, further compounding the potential for errors.

Therefore, despite the availability of various software tools designed to aid in project estimation and field assistance, there remains a distinct gap in the market for a solution that effectively integrates real-time data, caters to the specific needs of various construction trades, and provides interactive, personalized assistance through natural language processing. This gap highlights the need for an innovative approach to overcome the prevailing challenges faced by contractors and service technicians in the industry.

### SUMMARY

Embodiments of the present disclosure present technological improvements as solutions to one or more of the above-mentioned technical problems recognized by the inventor in conventional solutions.

The present invention relates to a computer-implemented method and a system for generating project estimates in real-time and offering field assistance. The system employs AI and NLP to process project requests, access real-time data for materials and labour, and generate detailed project estimates. It also offers installation tips, safety guidelines, and compliance information, enhancing user experience and project success rates. The invention allows for voice and text input, dynamic adjustments to estimates, integration with third-party software, and continuous improvement through feedback loops.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### OBJECT OF INVENTION

One of the objects of the present invention is to generate real-time, accurate project estimates in the construction and home improvement industries.

Another object of the present invention is to utilize natural language processing (NLP) for interpreting project requests and engaging in clarification dialogues.

Yet another object of the present invention is to offer an interactive interface that supports both voice and text inputs for submitting project requests.

### BREIF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a perspective view of a system as per the disclosed invention.

FIG. 2 depicts a flowchart of process as per the present invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the nonunderlined number is used to identify a general item at which the arrow is pointing.

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

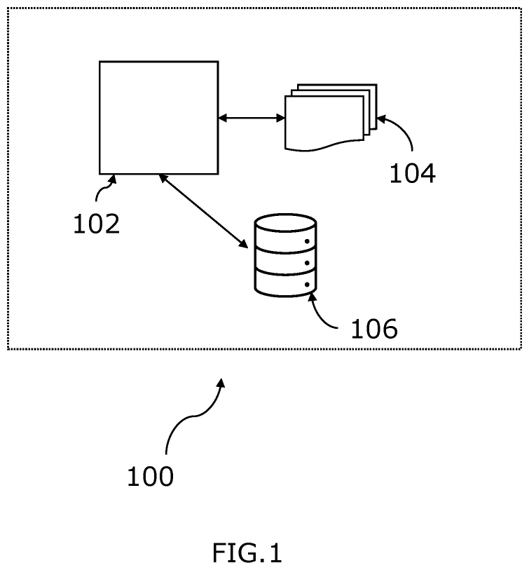

FIG. 1 depicts a perspective view of a system 100 as per the disclosed invention. The system 100 comprises a processor 102, communicably coupled to a memory 104 storing instructions that, when executed by the processor 102, perform one or more operations.

The processor 102 comprises an AI-Powered Assistant 104 that leverages an intuitive interface. The AI-Powered Assistant facilitates an advanced, user-centric approach to accessing real-time project estimates and field assistance. This assistant leverages artificial intelligence and natural language processing technologies to offer a highly accessible and versatile platform. It is the central interface through which all user interactions with the system take place. Whether users are seeking estimates, advice, or specific information, the assistant is the first point of contact, guiding users through their queries and requests. Through the assistant, users can directly access the full range of the system's functionalities. This includes generating project estimates, obtaining material costs and labour rates, and receiving field assistance like installation tips and safety guidelines.

The assistant is equipped with algorithms that allow it to learn from interactions, thereby improving its ability to provide relevant and accurate responses over time. This adaptive approach ensures that the system remains responsive to the evolving needs of its users.

For users who prefer speaking, the assistant can be activated and interacted with through voice commands. This is especially useful when hands-free operation is desired or when users are on the move. Users who prefer typing can interact with the assistant through text inputs. This mode is beneficial for detailed queries where specificity is key, or in environments where speaking aloud may not be feasible.

By supporting both voice and text inputs, the assistant caters to a wide range of scenarios and user preferences. Whether in a noisy construction site where voice commands may be more practical, or in a quiet office setting where typing is preferable, the assistant remains equally accessible.

The assistant significantly lowers the barrier to accessing sophisticated project estimation and field assistance services, making these tools available to a wider audience. By providing a direct and intuitive means of accessing the system's functionalities, the assistant helps users save time and increase productivity. The ability to understand and process natural language allows the assistant to offer a personalized experience, tailoring its responses to the specific needs and preferences of each user.

The AI-Powered Assistant tailors its interactions based on the user's behavior, preferences, and previous requests. This personalization makes the user experience more engaging and efficient, as the assistant anticipates the user's needs and preferences over time. Leveraging advanced AI and NLP technologies, the assistant provides immediate and relevant responses to user queries. This real-time interaction ensures that users receive timely information, which is crucial for decision-making in the construction and home improvement industries.

The AI-powered assistant integrates Natural Language Processing (NLP) and Natural Language Understanding (NLU) technologies enhances the system's accessibility and usability. NLP and NLU enable the assistant to comprehend user requests that are phrased in everyday language, including colloquialisms or industry-specific jargon. This understanding is crucial for interpreting the intent behind loosely structured or conversational input, making the system accessible to a broader range of users. When initial requests are unclear or too broad, the assistant uses its understanding of language and context to guide users toward more precise phrasing. This interactive guidance helps users refine their queries, ensuring they receive the most relevant responses.

The AI assistant uses NLP to not only interpret the initial user request but also to engage in a dialogue with the user for further clarification. This interactive process ensures that the system fully understands the project's scope, requirements, and any specific user preferences. The dialogue can involve asking the user for more details, offering options for the user to choose from, or clarifying ambiguities in the request. This capability mimics a human-like conversation, making the interaction more natural and efficient for the user. The assistant provides immediate feedback on user queries, which can include asking for clarification, suggesting refinements, or confirming understanding. This feedback loop is instrumental in educating users on how to interact with the system more effectively, leading to better outcomes. Each interaction contributes to the system's understanding of user intent and preferences, allowing it to respond more accurately in future interactions. This learning mechanism is key to improving the system's performance over time.

By analyzing data from previous interactions, the assistant identifies patterns in user preferences and behaviors. This analysis enables it to offer personalized suggestions that are aligned with individual user needs, past projects, or frequently requested information. The assistant's ability to pre-emptively offer options or information of likely interest to the user is a form of anticipatory service. This proactive approach to user engagement significantly enhances the overall user experience by making interactions more efficient and tailored to the user's specific needs.

The processor is further communicably coupled to a database 106 is structured to encompass a wide range of materials used in construction and home improvement projects, from common commodities like lumber and concrete to specialized fixtures and fittings. Labor rates are categorized by trade, skill level, and geographic location to provide accurate reflections of local market conditions. Real-time data is sourced from a variety of contributors, including material suppliers, wholesale marketplaces, labour unions, and industry surveys. Integrations with these sources are established through APIs (Application Programming Interfaces), web scraping, and direct data feeds, ensuring a continuous stream of updated information. The database is updated in real-time or near-real-time, depending on the data source. This ensures that the system's estimates are always based on the most current information, reflecting any fluctuations in the market. The processor 102 employs advanced data management techniques to handle the volume and velocity of incoming data. This involves data validation, normalization, and indexing to ensure that the information is accurate, consistent, and easily retrievable.

The system initially processes the project request submitted by the user through the interactive interface. This input might be in the form of a detailed description, a list of requirements, or even a series of questions and answers facilitated by the AI-powered assistant. Utilizing NLP, the system interprets the user's natural language input to extract key project parameters. These parameters include the scope of the project, specific materials requested, project dimensions, and any special requirements or preferences indicated by the user. With the project parameters defined, the system queries the comprehensive database to fetch real-time data on material costs and labor rates relevant to the project. This data is matched against the specific materials and labor types identified in the project parameters. The system also takes into account geographical location and market conditions, as material costs and labor rates can vary significantly by region. This ensures that the estimates are not just accurate but also applicable to the user's specific location. Using the project parameters and the real-time data obtained, the system calculates the overall project cost. This calculation considers the quantities of materials needed, derived from the project dimensions and requirements, and the labor costs, based on the labor rates for the required trades and the estimated time to completion. The system compiles a detailed breakdown of the project estimate, itemizing material lists, quantities, and the associated costs, along with labor costs. This breakdown provides transparency and allows users to understand where costs are allocated within their project.

The comprehensive project estimate is then presented to the user in a clear, concise, and accessible format. This presentation often includes not just the total estimated cost but also a breakdown that details individual material and labor costs. Users are given the opportunity to review the estimate and make modifications if necessary. This could involve changing material choices, adjusting project dimensions, or exploring cost-saving alternatives. The system can quickly recalculate the estimate based on any modifications made by the user. With a detailed project estimate in hand, users can make more informed decisions regarding their construction or home improvement projects. They can assess the feasibility of their project, explore different options to align with their budget, and plan their project with a clear understanding of the costs involved. The detailed breakdown of the estimate also aids in cost management, allowing users to identify potential areas for savings or to prioritize spending on certain aspects of the project.

This comprehensive approach to generating project estimates leverages the latest in AI, NLP, and database technologies to provide users with precise, real-time, and personalized project cost information. It significantly enhances the planning and execution of construction and home improvement projects by ensuring that estimates are as accurate and relevant as possible.

The processor 102 further includes field assistance features such as installation tips, safety guidelines, troubleshooting support, and compliance information significantly augments the value proposition of the system, making it not just a tool for project estimation but also a comprehensive resource for project execution. This multifaceted support is tailored to specific trades, ensuring that the information provided is directly applicable and immensely beneficial to the user.

The processor offers step-by-step instructions and best practices for installing various materials and components. This can include videos, diagrams, and written instructions created by experts in specific trades, helping users understand the most efficient and effective methods for installation tasks. Installation tips are customized for different trades, such as plumbing, electrical, carpentry, and roofing. This ensures that users receive advice that's directly relevant to their specific project needs and trade practices.

Safety guidelines provide users with information on how to minimize risks on the job site. This includes proper handling and usage of tools and materials, personal protective equipment (PPE) recommendations, and protocols for ensuring a safe working environment. The system also includes safety regulations and standards specific to different regions and trades. This helps users ensure that their work complies with local laws and industry standards, reducing the risk of accidents and legal issues.

Troubleshooting support offers solutions and advice for common problems encountered during projects. This can range from fixing installation errors to addressing unexpected material issues, providing users with a valuable resource for overcoming obstacles. In some implementations, the system could allow users to submit specific issues they're facing, with the AI-powered assistant offering customized advice based on the project details and available data. This interactive support can significantly reduce downtime and improve project outcomes.

Compliance information ensures that users are aware of the necessary building codes, environmental regulations, and industry standards relevant to their projects. This information is crucial for legal compliance and avoiding penalties. Since regulations can vary greatly by location, the system provides compliance information that's specific to the user's region. This tailored approach ensures that users have access to the most pertinent and up-to-date information.

With access to a wealth of trade-specific information and support, users can improve the efficiency and quality of their work. Installation tips and troubleshooting support help avoid common mistakes and ensure best practices are followed. Safety guidelines and compliance information help protect users from injuries and legal issues. By adhering to recommended practices and regulations, users can ensure a safer work environment and project execution. Tailoring this information to specific trades and project details makes the assistance highly relevant and practical. This personalization enhances the user experience and utility of the system, making it an indispensable tool for professionals and DIY enthusiasts alike.

The processor's provision of real-time data access and personalized advice represents a transformative approach to decision-making in the construction and home improvement sectors. This combination of timely, accurate information and customized recommendations empowers users to make well-informed decisions that significantly impact the success and efficiency of their projects. Access to real-time data ensures that users are making decisions based on the most current information available. Whether it's material costs, labor rates, or market trends, this timely data helps avoid the pitfalls of outdated information, which can lead to budget overruns or project delays. The ability to access this data on demand allows users to quickly respond to market changes. For instance, if the price of a key material spikes, users can immediately explore alternatives or adjust project specifications to mitigate cost impacts. The processor's capability to generate various estimates quickly enables users to compare different project scenarios side by side. This comparison might include variations in materials, designs, or timelines, offering a clear perspective on how each choice affects the overall budget and project outcome. With the ability to perform these comparisons, users can identify the most cost-effective options without compromising on quality. This helps in optimizing the project budget, ensuring that resources are allocated efficiently.

By incorporating user feedback into the estimation process, the processor can adapt and refine its algorithms for future estimates. This feedback loop ensures that the system learns from each project, improving its accuracy and relevance over time. User feedback allows the system to adjust its estimates to better align with actual project outcomes. This could involve tweaking material cost estimates, labour rates, or even the estimated duration of certain tasks, based on user-reported data.

Analyzing historical data enables the system to identify trends in material costs, labor rates, and project timelines. This analysis can help predict future changes in the market and adjust estimates accordingly. By examining past projects, the system can glean insights into which estimates were most accurate and which consistently deviated from actual costs. These insights can be used to recalibrate the estimation algorithms, enhancing their predictive accuracy.

Integration with project management and accounting software allows for the seamless flow of data between systems. This connectivity ensures that estimates and project data are easily accessible within the tools that users already rely on for project planning and execution. By integrating estimate data with project management software, users can directly translate estimates into actionable project plans. This includes task scheduling, resource allocation, and progress tracking, all informed by the initial project estimates. Integrating with accounting software simplifies the financial management of projects. Estimates can be compared against actual expenses in real-time, facilitating budget adjustments and financial reporting.

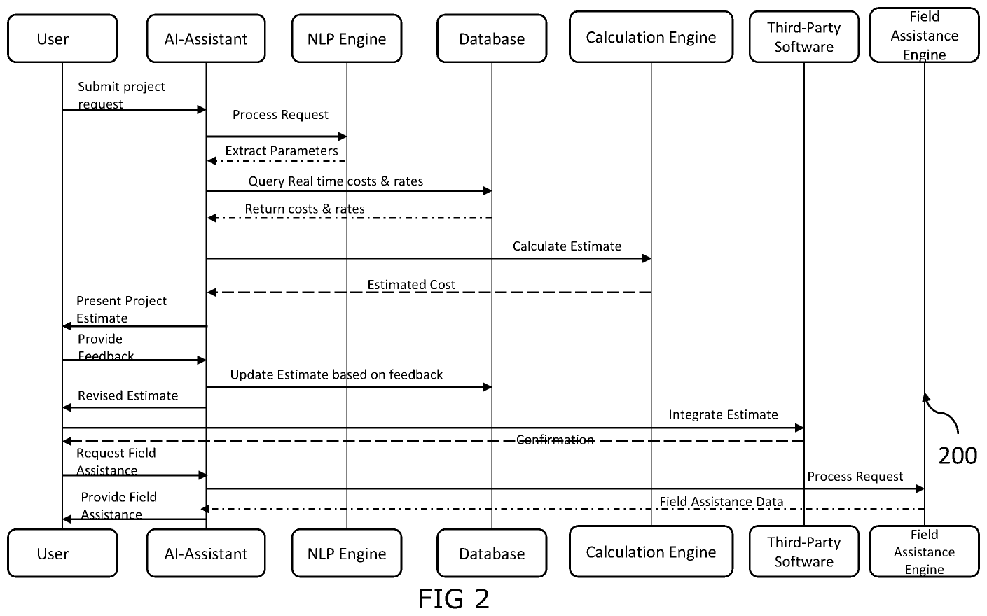

FIG. 2 depicts a flowchart of process as per the present invention. In operation, a user initiates a request through the interactive interface, which could range from describing a specific construction or home improvement project to seeking particular forms of assistance. Upon receiving this input, the AI-powered assistant is activated, leveraging Natural Language Processing (NLP) to understand and process the user's request. This step is crucial as it allows the system to interpret the request in the context of natural, conversational language, making the interaction as intuitive as possible for the user. Following the initial interpretation, the processor engages in a dialogue with the user to clarify any ambiguities and refine the project details and parameters. This interaction ensures that the system has all the necessary information to proceed with an accurate estimate, demonstrating the system's capability to adapt and respond to the user's specific needs through a conversational interface. Once the project parameters are clearly defined, the processor queries a comprehensive database to retrieve real-time data on material costs and labor rates. This step is vital for ensuring that the project estimate reflects the most current market conditions, thereby providing the user with an accurate and reliable financial outlook for their project. With all the necessary data at hand, the system then compiles a comprehensive project estimate. This estimate includes a detailed breakdown of material lists, quantities, and associated costs, along with labor costs, all calculated based on the real-time data and the clarified project parameters. This detailed estimate offers a clear and concise overview of the expected project costs, enabling the user to make informed decisions regarding their project's feasibility and scope. In addition to providing a detailed cost estimate, the system also delivers tailored field assistance. This assistance includes installation tips, safety guidelines, troubleshooting support, and compliance information, all customized to the specific needs of the project and the user. This feature not only enhances the user's ability to plan and budget for their project but also supports the efficient and safe execution of the project, ensuring that the user has access to a wealth of relevant information and guidance.

One or more components of the invention are described as unit for the understanding of the specification. Additional or less units can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for generating real-time project estimates in the construction and home improvement industries, comprising:
receiving a project request from a user via an interactive interface;
processing the request using natural language processing (NLP) to identify project parameters;
accessing a database for real-time material costs and labor rates;
calculating an estimated project cost based on the identified parameters and real-time data;
presenting the project estimate to the user.

2. The method of claim 1, wherein the interactive interface supports voice and text inputs.

3. The method of claim 1, further including the step of refining the project estimate based on user feedback.

4. A system for providing real-time project estimates in the construction and home improvement industries, comprising:
a processor and memory to execute instructions for activating an AI-powered assistant;
a module for employing NLP to interpret user requests;
a database interface for querying real-time material costs and labor rates;
a calculation engine to compile project estimates.

5. The system of claim 4, wherein the AI-powered assistant provides personalized project recommendations.

6. The system of claim 4, further including integration with third-party project management and accounting software.

7. A computer-implemented method for delivering field assistance, comprising:
generating installation tips, safety guidelines, troubleshooting support, and compliance information;
tailoring the provided information to the specific trade involved in the user's project.

8. The method of claim 7, where the field assistance is dynamically updated based on evolving industry standards and regulations.

9. A method for continuously improving project estimate accuracy, involving:
collecting user feedback on provided estimates;
analyzing historical project data;
adjusting future estimates based on the feedback and data analysis.

10. The system of claim 4, further comprising a feedback loop mechanism for enhancing the accuracy of project estimates using user feedback and historical data analysis.

11. The method of claim 1, further including the step of offering a comparison tool for users to evaluate different project scenarios based on various inputs.

12. A system for updating the database of real-time material costs and labour rates, comprising:
an automated data collection module for gathering updated cost information from multiple sources;
a data processing module for validating and integrating the collected data into the database.

13. The method of claim 1, wherein the detailed project estimate includes a dynamic adjustment feature for material quantities and costs in response to changes in project specifications.

14. The system of claim 4, wherein the database includes a plurality of data sources, enabling the selection of the most cost-effective materials and labor options.

15. A method for integrating compliance documentation and installation guidelines specific to the project's geographic location into the project estimate.

16. The system of claim 4, capable of generating and delivering project estimates and field assistance in multiple languages.

17. The method of claim 1, including a user interface customization feature allowing users to specify preferences for how project estimates and related information are presented.

18. A computer-implemented method for predictive analysis, forecasting future trends in material costs and labor rates using historical data and machine learning algorithms.

19. The system of claim 4, wherein the AI-powered assistant is further capable of conducting a dialogue with the user for clarifying project details, using an advanced NLP model to interpret and respond to complex queries.

20. A method for secure data exchange between the system and third-party services, ensuring user data privacy and compliance with data protection regulations when accessing real-time material costs and labor rates.
